(19) United States
(12) Patent Application Publication
(10) Pub. No.: US 2025/0000173 A1
(43) Pub. Date: Jan. 2, 2025

(54) DELIVERY DEVICE AND DELIVERY SYSTEM

(71) Applicant: NICOVENTURES TRADING LIMITED, London (GB)

(72) Inventors: Rosa GALATI, London (GB); Sally BELL, London (GB); Rob KERSEY, Brighton Sussex (GB); Chris YIN, Shenzhen (CN)

(21) Appl. No.: 18/690,448

(22) PCT Filed: Aug. 3, 2022
(86) PCT No.: PCT/GB2022/052042

§ 371 Date: Mar. 8, 2024

(30) Foreign Application Priority Data
Sep. 10, 2021 (CN) 2021110647465
Sep. 22, 2021 (GB) 2113506.6

(51) Int. Cl. A24F 40/60; A24F 40/53; H01M 10/48

(52) U.S. Cl. CPC A24F 40/60; A24F 40/53; H01M 10/48; H01M 2220/30

(57) ABSTRACT

A delivery device includes a light source to provide visual feedback to a user and a secondary feedback component. A processor determines a change in status of the delivery device and a controller controls the light source and actuates the secondary feedback component in response to a signal from the processor to provide secondary feedback in addition to the visual feedback provided by the light source. Also disclosed is a delivery system including the delivery device and an aerosol generating module configured to provide aerosol to a user when power is supplied by the battery of the delivery device to a heater configured to provide heat to the aerosol generating module.

### RELATED APPLICATIONS

The present application is a National Phase entry of PCT Application No. PCT/GB2022/052042 filed Aug. 3, 2022, which claims priority to CN application No. 2021110647465 filed Sep. 10, 2021 and GB Application NO. 2113506.6 filed Sep. 22, 2021, each of which is hereby incorporated by reference in their entirety.

### TECHNICAL FIELD

The present specification relates to a delivery device for use in a delivery system, such as an aerosol provision system, and in particular a non-combustible aerosol provision system.

### BACKGROUND

Smoking articles, such as cigarettes, cigars and the like burn tobacco during use to create tobacco smoke. Attempts have been made to provide alternative delivery systems to these articles by creating products that release compounds without combustion. Examples of such delivery systems are so-called “heat not burn” products or tobacco heating devices or products, which release compounds by heating, but not burning, a substrate. For example, tobacco heating devices heat an aerosol generating substrate, which may be tobacco or other non-tobacco products which may or may not contain nicotine, to form an aerosol by heating the substrate without burning it.

### SUMMARY

According to an aspect of the invention, there is provided a delivery device comprising a light source to provide visual feedback to a user; a secondary feedback component, a processor configured to determine a change in status of the delivery device, and a controller to control the light source and to actuate the secondary feedback component in response to a signal from the processor to provide secondary feedback in addition to the visual feedback provided by the light source indicative of a change in status of the delivery device.

The secondary feedback component may be a vibration component to generate haptic feedback to a user, and the controller may be configured to actuate the vibration component to provide both visual and haptic feedback indicative of a change in status of the delivery device. In other embodiments the secondary feedback component may be a buzzer or other device capable of generating an audible indication or alarm.

The delivery device may comprise a battery. The processor may then be configured to determine that a change in status of the delivery device has occurred based on a state of charge of the battery.

A state of charge of the battery may be determined based on a determination of its voltage. It is also possible to determine the state of charge of the battery based on a predetermined reduction in charge level of the battery relative to its fully charged state.

The processor may be configured to determine that a change of status of the delivery device has occurred when the charge level of the battery reaches 40%, 30%, 20% and/or 10% of its fully charged state.

The controller may be configured to actuate the vibration component at a vibration frequency that depends on a determined state of charge of the battery.

The vibration component may be actuated for a period of time depending on the state of charge of the battery.

The color of the light source may change in response to a signal from the processor to provide visual feedback that the status of the delivery device has changed.

The controller may be configured to illuminate the light source in a different color depending on the determined state of charge of the battery.

The delivery device may comprise a buzzer. The controller may then be configured to actuate the buzzer in response to a signal from the processor to provide audible feedback indicative of a change in status of the delivery device.

According to another aspect of the invention, there is provided a method of controlling a delivery device comprising a processor configured to determine a change in a status of the delivery device and a controller to control a light source in response to a signal from the processor to visually indicate that the status of the delivery device has changed, the method including configuring the controller to actuate a vibration element to provide haptic feedback indicative of said change in status in addition to controlling the light source.

### BRIEF DESCRIPTION OF THE DRAWINGS

Example embodiments will now be described, by way of example only, with reference to the following schematic drawings, in which:

FIG. 1 is a schematic drawing of a device in accordance with an example embodiment;

FIG. 2 is an exploded view of a control module of the device shown in FIG. 1;

FIG. 3 is a cross-sectional view of the assembled control module of FIG. 2;

FIG. 4 is a partial enlarged view of the control module of FIG. 2; and

FIG. 5 is a block diagram to indicate the method of operation of the delivery device according to an embodiment of the invention.

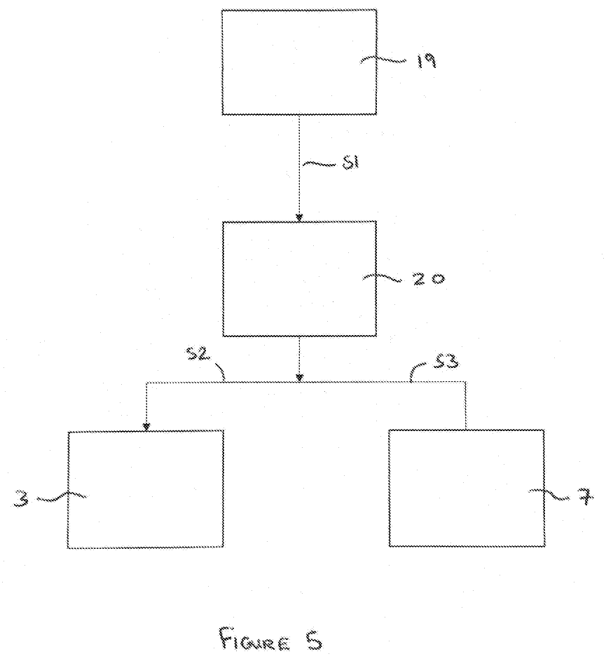

### DETAILED DESCRIPTION

As used herein, the term “delivery system” is intended to encompass systems that deliver at least one substance to a user, and includes: non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

Embodiments according to the invention provide a delivery system 1 that includes a housing 2 having an opening formed in a wall of the housing 2 and through which a light source 3 within the housing 2, such as a light emitting diode (LED), can be seen.

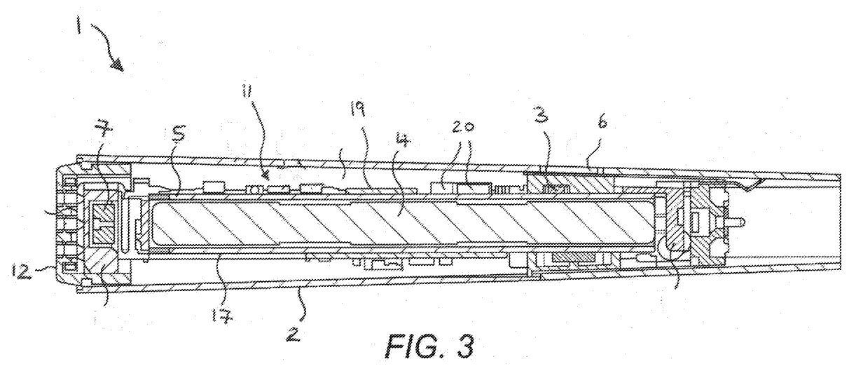

It is common for delivery devices 1 to have a light source such as a light-emitting diode (LED) 3 so that a user can tell if the device is powered, or to signal other functions such as the need for charging a depleted rechargeable battery 4. The LED 3 is provided on a circuit board 5 and an opening 6 is provided in the housing 2 through which the LED 3 can be seen, or in which the LED 3 is located. For this purpose, the opening 6 and the LED 3 on the circuit board 5, are positioned so that they are in alignment when the device 1 is assembled, i.e. the LED 3 is positioned beneath the opening 6. An LED 3 mounted to the circuit board 5 beneath the opening 6 is shown in FIG. 3.

The delivery system 1 includes a vibration motor 7 to provide haptic feedback to a user in the form of vibrations, similar to that provided in a mobile phone. In certain embodiments, the delivery device 1 also includes a buzzer 8 to generate an audible signal to the user. The vibration motor 7, and any buzzer 8, can be used to provide information to the user of the status of the delivery device 1 such as, for example, whether it is switched on, or its state of charge.

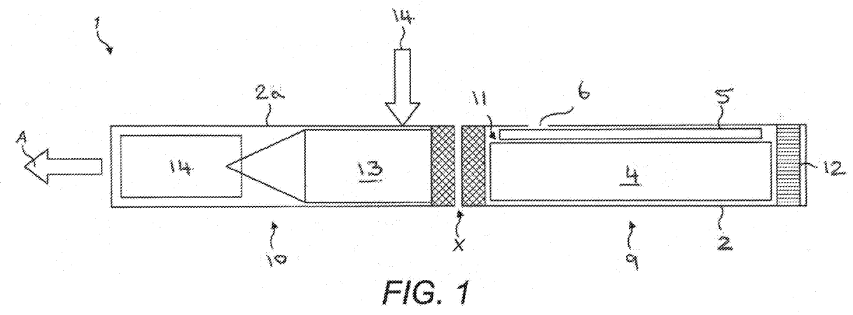

FIG. 1 is a schematic drawing of a delivery system 1 in the form of a non-combustible aerosol provision device, indicated generally by the reference numeral 1, in accordance with an example embodiment. The system 1 comprises two main components: delivery 9, and aerosol generating module 10.

The first component 9 of the device 1 includes a control module 11, which includes the battery 4 and circuit board 5. The control module 11 is received within the housing 2 which encloses the control module 11 and forms the external appearance of the device 1. The housing 2 may be a tubular sleeve, in which case the control module 11 is inserted into the housing 2 from one open end during assembly of the device 1 and the open end of the housing 2 is then closed by an end cap 12 so that the housing 2 is closed. However, the housing 2 may, alternatively, be formed from multiple parts or shells that are attached together to form an enclosure around the control module 11. The housing 2 is preferably formed from a metal, such as aluminum, although other materials for the housing 2 are also possible.

The first component 9 includes a connector, such as a USB connector, which may enable connection to be made to a power source for charging the battery 4 of the control module 11. The connector may be accessible through the end cap 12.

The second component 10 of the device 1 includes a heater 13 and a liquid reservoir 14 that may collectively form an aerosol generating module. The first and second components 9, 10 may be modular, i.e. the second component 10 may have its own housing 2a and be separable from the first component 2 (at a join marked X in FIG. 1) for repair or replacement. A releasable electrical connection joins the first and second components 9, 10 to enable power and control signals to be transmitted between them. However, the first and second components 9, 10 may not be separable, other than by disassembly of the device 1. More specifically, the first and second components 9, 10 may be connected together during assembly and received within the same integral housing 2 to form an integral unit. In some examples, the device 9 comprises the heater 13, and the aerosol generating module comprise an aerosol generating substrate which is heated by the heater 13. The aerosol generating substrate may be a solid substrate or may be a liquid within a liquid reservoir 14.

When the device of FIG. 1 is used, air is drawn into an air inlet of the heater 13, as indicated by the arrow 14. The heater 13 is controlled by the control module 11 and heats the incoming air. The heated air is directed to the liquid reservoir 14, where an aerosol is generated. The aerosol exits the device 1 at an air outlet, as indicated by the arrow A, into the mouth of a user of the device 1.

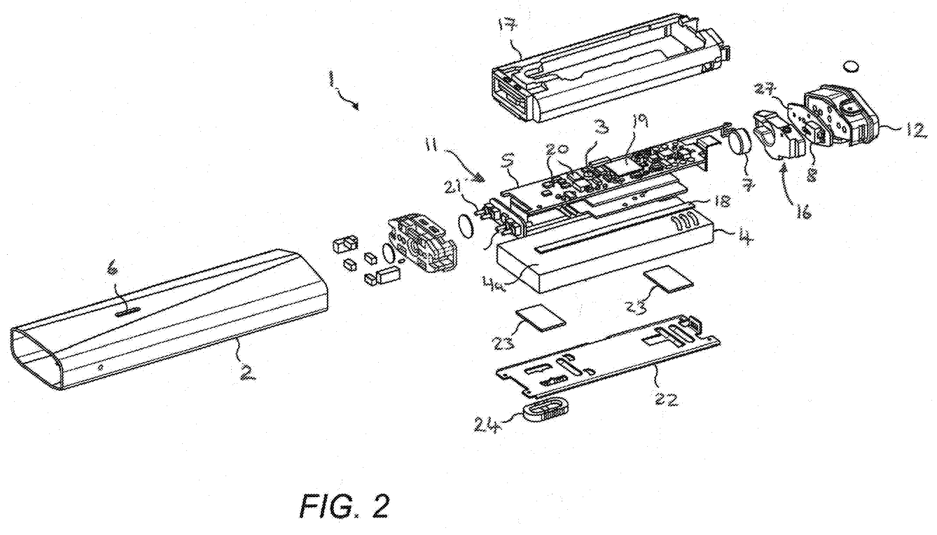

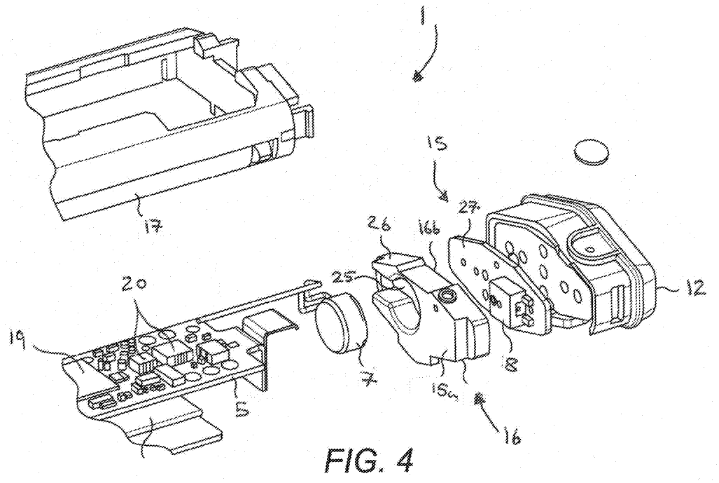

FIG. 2 is a more detailed and exploded view of the control module 11 shown in FIG. 1, with the second component 10 omitted, and FIG. 3 is a cross-sectional side elevation of the first component 9 of FIG. 1. FIG. 4 is a partial view of the exploded perspective view of FIG. 2, to show an assembly 15 of an end part of the first component 9 of the device 1 more clearly. The assembly 15 comprises an elastomeric support member 16 that receives and mounts the vibration motor 7 and, optionally, the buzzer 8.

As shown in FIG. 2, the housing 2 is in the form of a sleeve and the remaining components of the control module 11 are inserted into the housing 2 from one end. The end is then closed by the end cap 12, which can be an interference fit in the first component 9 of the housing 2, or be attached to the housing 2 with mechanical fasteners or adhesive.

The control module 11 includes a frame or carrier 17 in which the battery 4 is received and held. The circuit board 5 is mounted to the outside of the carrier 17 and is supported by both the carrier 17 and by the outside of one major face 4a of the battery 4. An insulated spacer or adhesive support pad 18 may be located between the major face 4a of the battery 4 and the circuit board 5 where they overlie each other. A processor 19 and a controller 20 are mounted to the circuit board 5, which also has connectors 21 for electrical connection of the circuit board 5 to the aerosol generating module of the second component 10. These connectors 21 are positioned on a section of the circuit board 5 that overhangs one end of the carrier 17. Whilst the processor 19 and controller 20 are referenced as separate components, it will be understood that the processor 19 and controller 20 may be embodied in a single integrated component such as a microcontroller. The microcontroller may also include a memory for storing data relating to a change of status of the device.

A metal or conductive plate 22 is mounted to the carrier 17 and to the other major face 4b of the battery 4 on the opposite side of the battery 4 to the circuit board 5. An insulated pad or spacer 23 may be located between the other major face 4b of the battery 4 and the metal plate 18 and may be adhesive so that the metal plate 22 is held in place on the other major face 4b of the battery 4. The metal plate 22 forms an electrical connection between the battery 4 and processor 19 and controller 20, as well as other control elements, on the circuit board 5.

The control module 11 includes a press button on/off switch 24, which is mounted to the metal plate 22 and is accessible through an aperture in the housing 2. Pressing the on/off switch 24 connects, or disconnects, the battery 4 from the control elements such as the processor 16 and controller 16a, on the circuit board 5, thereby switching the device 1 on or off, or performing other control functions as required.

With further reference to FIGS. 2 and 4, the vibration motor 7 is received within the housing 2 between the carrier 17 and the end cap 12. The vibration motor 7 is received within a support member 16 or molding which is made from an elastomeric material. The support member 16 is preferably made from rubber, and most preferably silicone rubber, and supports the vibration motor 7 and dampens the vibrations generated by the vibration motor 7. The support member 16 has an opening or recess 25 in which the vibration motor 7 is a snug or press fit so that it can be pressed into the recess 25 and held securely within it. The support member 16 has an external shape which corresponds to the inner shape of the housing 2 so that the external surface 26 of the support member 16 lies in contact with the internal surface of the housing 2, or within the end cap 12. The support member 16 may be partly received in the cap 12 and extend from the cap 12 into the housing 2. The support member 16 may be a press-fit or interference fit with the cap 12 and/or the housing 2, so that it is held in a stable condition within the housing 2. Being made from an elastomeric material, the support member 16 may ‘give’ during assembly to enable it to be inserted into the housing 2 and/or cap 12 so as to be retained firmly therein between the end of the carrier 17 and the end cap 12.

In certain embodiments, a relatively rigid panel may lie in contact with the vibration motor 7 or a part of the vibration motor 7 that remains visible after it is received in its recess 25 in the support member 16. This panel may also be in contact with the inside wall of the housing 2. Vibrations of the vibration motor 7 are then transmitted to the housing 2 via the relatively rigid panel in addition to, or instead of, via the support member 16.

If the delivery device 1 is provided with a buzzer 8, it is mounted to a charge board 27, which controls the charging of the device via a USB cable or suchlike. The charge board 27 is also received in one end of the housing 2 between the carrier 17 and the end cap 12, and is preferably received in the end cap 12 itself. When the buzzer 8 is received in the support member 16, the charge board 27 lies substantially against the major face 16b of the support member 16.

The buzzer 8 is preferably also received within the support member 16, and the support member 16 is provided with an additional recess or opening (not shown) to receive the buzzer 8. Similarly to the vibration motor 7, the buzzer 8 may be a press fit into its recess in the support member 16. Preferably, the support member 16 has two opposing major faces 15a, 15b with the recess 25 for the vibration motor 7 being formed in one face 15a, and the recess for the buzzer 8 being formed in the opposing face 15b, so that the vibration motor 7 and the buzzer 8 are both protected and remain separated from each other by an internal wall of the support member 16. It will be understood, particularly from FIG. 4, that the vibration motor 7 and the buzzer 8 are offset laterally from each other within the support member 16, i.e. they are in side-by-side orientations, and are separated by an internal central dividing wall of the support member 16. The vibration motor 7 and the buzzer 8 are also inserted into the support member 16 from opposite sides of the support member 16, i.e. the recesses are in opposite faces 15a, 15b of the support member 16. Each recess is shaped to receive the vibration motor 7 and the buzzer 8, respectively. Therefore, the device 1 is easy to assemble. Furthermore, the support member 16 fits into the housing 2 and/or end cap 12 and is held firm without any additional fasteners.

As described above, the light source 3 may illuminate or change color in response to a change in status of the device 1. A change of status of the device 1 may occur when the battery 4 reaches a certain state of charge. For example, a change of status may be determined to have occurred as a result of the battery 4 dropping by, or to, a predetermined voltage, or its charge capacity reducing to a percentage level relative to a fully charged state of the battery 4. It will be appreciated that the light source 3 may change or illuminate in different ways depending on the status of the device 1 being indicated thereby.

A user may not immediately notice that the light source 3 has been illuminated or has changed color to indicate a change of status, such as charge depletion. Therefore, it is desirable to provide one or more subsidiary or auxiliary indications, or at least a trigger to notify the user that the light source has changed to signify a change in status of the device 1. The haptic feedback provided by the vibration component 7 therefore provides the user with a prompt to look at the light source 3 to determine the new status of the device 1.

To provide a secondary indication that the status of the device 1 has changed, the vibration component 7 will generate haptic feedback to a user. If the vibration of the device 1 itself is not enough to indicate that the device 1 requires charging for example, it will at least prompt the user to look at the light source 3 and thereby determine what change of status has occurred.

The processor 19 is can be pre-programmed to respond to a predetermined change of status of the device 1. The controller 20 is then responsive to a signal from the processor 19 to control the light source 3 and to actuate the vibration component 7 to provide both visual and haptic feedback indicative of a change in status of the delivery device 1. The visual and haptic feedback may be provided simultaneously. In certain embodiments, the vibration component 7 may be actuated as a direct result of a change in the light source 3, i.e. the vibration component 7 may actuate in response to the light source 3 illuminating or changing color, or as a result of a different sequence of lights being illuminated. Alternatively, the vibration component 7 may actuate in response to a separate signal received from the controller 20 and in response to a signal received from the processor 19.

In some embodiments, the processor 19 may be configured to determine that a change of status of the delivery device 1 has occurred when the charge level of the battery 4 reaches 40%, 30%, 20% and/or 10% of its fully charged state. A change of status may have occurred when the battery 4 reaches one of, or any or all, of these charge conditions. However, it will be understood that the processor 19 can be programmed to determine that a change of status of the device 1 has occurred at any battery charge level. The processor 19 may determine when a particular voltage drop in the battery 4 has occurred.

The controller 20 may actuate the vibration component 7 at a vibration frequency that depends on a determined state of charge of the battery 4. For example, the vibration component 7 may vibrate at a higher frequency as the charge level reduces towards zero. Furthermore, the vibration component 7 may generate pulses for a period of time depending on the state of charge of the battery 4. The frequency, or length of the pulses may change depending on the detected charge level. For example, the pulses may be shorter and more frequent at lower charge levels, when the battery 4 is close to reaching a fully depleted state.

In some embodiments, the delivery device 1 may also provide audible feedback, i.e. the delivery device may be provided with a buzzer 8. The controller 20 may also be configured to actuate the buzzer 20 to provide audible feedback indicative of a change in status of the delivery device 1. The buzzer 8 may be activated simultaneously with the vibration motor 7. In some circumstances, the vibration motor 7 may be activated without the buzzer 8. For example, when the charge level of the battery has depleted to a first state. The buzzer 8 and the vibration motor 7 may be actuated simultaneously at other status conditions, i.e. when the battery 4 is closer to being fully discharged. FIG. 4 is a block diagram to indicate the functioning of the device 1. Processor 19 identifies when a pre-programmed change in the status of the device 1 has occurred and sends a signal S1 to a controller 20. In response to signal S1, controller 20 sends signals S2 and S3 to the light source 3 and the vibration motor 7, respectively, to provide both visual and haptic feedback to the user to indicate that the status of the device 1 has changed. As previously mentioned, the light source 3 may illuminate or change in a particular way depending on the status of the device 1 being indicated. Therefore, the haptic feedback provided by the vibration motor 7 will prompt a user to look at the light source 3 to determine which particular change in status has occurred, following which the user may act accordingly. For example, they may wish to plug in the device 1 in order to recharge the battery 4, or at least be on notice that the device 1 needs recharging shortly.

It will also be understood that the vibration motor could be omitted, so that the secondary indication is only an audible one, in which case activation of the buzzer 8 would prompt a user to look at the light source to determine how the status of the device 1 has changed.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A delivery device comprising:
a light source to provide visual feedback to a user;
a secondary feedback component,
a processor configured to determine a change in status of the delivery device, and
a controller to control the light source and to actuate the secondary feedback component in response to a signal from the processor to provide secondary feedback in addition to the visual feedback provided by the light source indicative of a change in status of the delivery device.

2. A delivery device according to claim 1, wherein the secondary feedback component is a vibration component to generate haptic feedback to a user, the controller being configured to actuate the vibration component to provide both visual and haptic feedback indicative of a change in status of the delivery device.

3. A delivery device according to claim 2, comprising a battery, the processor being configured to determine that a change in status of the delivery device has occurred based on a state of charge of the battery.

4. A delivery device according to claim 3, wherein the state of charge of the battery is determined based on its voltage.

5. A delivery device according to claim 3, wherein the state of charge of the battery is determined based on a predetermined reduction in charge level of the battery relative to its fully charged state.

6. A delivery device according to claim 5, wherein the processor is configured to determine that a change of status of the delivery device has occurred when the charge level of the battery reaches 40%, 30%, 20% and/or 10% of its fully charged state.

7. A delivery device according to any of claims 2 to 6, wherein the controller is configured to actuate the vibration component at a vibration frequency that depends on a determined state of charge of the battery.

8. A delivery device according to any of claims 2 to 6, wherein the processor is configured to actuate the vibration component for a period of time depending on the state of charge of the battery.

9. A delivery device according to any of claim 2, wherein the controller is configured to change the color of the light source in response to a signal from the processor to provide visual feedback that the status of the delivery device has changed.

10. A delivery device according to claim 9, wherein the controller is configured to illuminate the light source in a different color depending on the determined state of charge of the battery.

11. A delivery device according to any of claims 1 to 6, comprising a buzzer, wherein the controller is configured to actuate the buzzer in response to a signal from the processor to provide audible feedback indicative of a change in status of the delivery device.

12. A delivery system comprising:
a delivery device according to any one of claims 1 to 6; and
an aerosol generating module configured to provide aerosol to a user when power is supplied by the battery of the delivery device to a heater configured to provide heat to the aerosol generating module.

13. A method of controlling a delivery device comprising a processor configured to determine a change in a status of the delivery device and a controller to control a light source in response to a signal from the processor to visually indicate that the status of the delivery device has changed, wherein the method includes actuating a vibration element to provide haptic feedback indicative of said change in status in addition to controlling the light source.
